(19) United States
(12) Patent Application Publication
(10) Pub. No.: US 2014/0063416 A1
(43) Pub. Date: Mar. 6, 2014

(54) BACKLIGHT UNIT AND LIQUID CRYSTAL DISPLAY DEVICE

(71) Applicant: Takaharu Shimizu, Osaka-shi (JP)

(72) Inventor: Takaharu Shimizu, Osaka-shi (JP)

(73) Assignee: SHARP KABUSHIKI KAISHA, Osaka-shi, Osaka (JP)

(21) Appl. No.: 14/114,815

(22) PCT Filed: May 21, 2012
(86) PCT No.: PCT/JP2012/062916

§ 371 Date: Oct. 30, 2013

(30) Foreign Application Priority Data
May 26, 2011 (JP) 2011-118004

(51) Int. Cl. F21V 8/00; G02F 1/1335

(52) U.S. Cl. CPC G02B 6/0013; G02F 1/133615
USPC 349/65; 362/609

(57) ABSTRACT

In order to prevent the occurrence of unevenness of planar light and reduce consumption energy, a backlight unit (1) includes: a light source unit (3); a light guide plate (2) in which light from the light source (3) enters through a light receiving surface (22) and in which planar light is emitted through a light emitting surface (21); an optical sheet (4) that is arranged on the side of the light receiving surface (22) of the light guide plate (2); a first optical member (61) that is formed on a portion of the optical sheet (4) close to the light source (3) and that reflects the light; and a second optical member (62) that is formed on a portion of the optical sheet (4) close to the first optical member (6).

### TECHNICAL FIELD

The present invention relates to an edge light-type backlight unit and a liquid crystal display device including such an edge light-type backlight unit.

### BACKGROUND ART

A liquid crystal display device includes a liquid crystal panel unit and a backlight unit that is arranged on the back surface of the liquid crystal panel unit; the liquid crystal panel unit adjusts the transmittance (the amount of transmission) of light from the backlight unit to display an image on the front surface of the liquid crystal panel unit.

The backlight unit described above is broadly divided into two types. One is a light guide plate type (edge light type) in which light enters through the side surface of a light guide plate; the other is a direct type in which a light source is arranged on the back surface of a liquid crystal module.

Conventionally, since the edge light-type backlight unit has structure where light enters through the side surface of the light guide plate, it is difficult to emit large planar light whose brightness distribution is uniform, with the result that the backlight unit is often used in a small-sized liquid crystal display device such as the monitor of a notebook PC or the monitor of a play device. In recent years, since for example, it has been increasingly required to reduce the thickness and the size of the liquid crystal display device, the accuracy of the light guide plate has been enhanced and the brightness of an LED used as a light source has been increased, large planar light whose brightness distribution is uniform has been able to be emitted, with the result that the backlight unit is increasingly used in a large-sized liquid crystal display device such as a large-sized television set.

The edge light-type backlight unit will be described below. The edge light-type backlight unit includes a light source unit in which a plurality of LEDs are aligned and arranged, a light guide plate that receives light emitted from the light source unit through a light receiving surface on a side surface and that emits it as planar light through a light emitting surface on a main surface, an optical sheet that is arranged adjacent to the light emitting surface of the light guide plate and a reflective sheet that is arranged adjacent to the surface on the opposite side to the light emitting surface of the light guide plate. These members are arranged within a backlight chassis.

In the edge light-type backlight unit described above, in order to reduce the unused part of the light emitted from the light source unit, it is preferable to bring the light source unit closest to the light guide plate. However, since the light guide plate may be expanded by heat, in order for the light guide plate and the light source unit to be prevented from being brought into contact by the expansion, the light guide plate and the light source unit are arranged with a gap therebetween.

Since the light emitted from the light source (LEDs) is diffused light, when the gap is present between the light guide plate and the light source unit, the light emitted from the LEDs does not enter the light receiving portion of the light guide plate and leaks through the gap and is diffusely reflected off the optical sheet, the reflective sheet and the like, with the result that the light may leak out of the backlight unit (leakage light may occur). When the leakage light occurs, in the planar light emitted from the backlight unit, a linear portion (hereinafter referred to as a bright line) whose brightness is high is produced in the vicinity of the light source unit. When the bright line is produced, the uniformity of the brightness of the planar light is lost, and the display quality of an image displayed in the liquid crystal display device is lowered.

Hence, in JP-A-2004-341294, in a portion a predetermined distance apart from a side edge portion of the optical sheet, a bright line prevention layer for absorbing leakage light is formed. As described above, the bright line prevention layer of the optical sheet is formed, and thus the leakage light is absorbed, and the production of the bright line in planar light is reduced. The bright line prevention layer is formed in the portion apart from the side edge portion of the optical sheet, and thus a flaw such as a crack that is produced by pushing in a metal blade (such as a Thomson blade or a Pinnacle blade) when the optical sheet is clipped out is reduced.

### RELATED ART DOCUMENT

### Patent Document

Patent document 1: JP-A-2004-341294

### DISCLOSURE OF THE INVENTION

### Problems to be Solved by the Invention

In the backlight unit of JP-A-2004-341294, since leakage light that leaks from the gap between the light source unit and the light guide plate, of the light emitted from the light source unit, is absorbed by the bright line prevention layer, it is possible to reduce the production of the bright line. However, since the leakage light is not utilized as planar light, the rate of utilization of the light from the light source is reduced. Hence, in order to increase the brightness of the planar light, it is necessary to increase the brightness of the light emitted from the light source unit, with the result that consumption energy is increased.

Hence, an object of the present invention is to provide a backlight unit that is an edge light-type backlight unit, that prevents the occurrence of unevenness of planar light and that can reduce consumption energy and a liquid crystal display device that utilizes such a backlight unit.

### Means for Solving the Problem

To achieve the above object, according to the present invention, there is provided a backlight unit including: a light source; a light guide plate in which light from the light source enters through a light receiving surface on a side surface and in which planar light is emitted through a light emitting surface on a main surface; an optical sheet that includes a protrusion portion which is arranged on a side of the light receiving surface of the light guide plate and which protrudes to a side of the light source as compared with the light guide plate; a first optical member that is formed on the protrusion portion and a portion of the optical sheet close to the light source and that reflects the light; and a second optical member that is formed on an opposite side to the light source with respect to the first optical member of the optical sheet and that absorbs part or all of the light entering the light guide plate.

In this configuration, the light displaced from the light receiving surface, of the light emitted from the light source, is reflected off the first optical member formed on the projection portion, and thus the light can be made to enter through the light receiving surface. Since when the light enters the second optical member, the light is reduced (shielded), it is possible to reduce the emission of the light which is not repeatedly reflected (not diffused), of the light entering the light guide plate, from the vicinity of the light source.

Thus, it is possible to reduce the following phenomenon: the amount of the light emitted through the light emitting surface is increased in the vicinity of the light source, and thus a linear region (bright line) whose brightness is high is produced in the planar light. Since the light once displaced from the light receiving surface is reflected to be guided to the light receiving surface, the rate of utilization of the light emitted from the light source is increased, and thus it is possible to reduce the decrease in brightness and to reduce consumption energy.

Preferably, in the configuration described above, the second optical member has a reflection rate lower than the first optical member or reduces the amount of transmission of the light entering the light guide plate.

Preferably, in the configuration described above, the optical sheet includes a plurality of optical sheet members, the first optical member is formed on at least one of the optical sheet members and the second optical member is formed on at least one of the optical sheet members. Here, preferably, the first optical member is formed on the optical sheet member closest to the light guide plate.

Preferably, in the configuration described above, the second optical member is formed on an upper surface of the optical sheet, and the first optical member is formed on an upper surface of the second optical member.

Preferably, in the configuration described above, the first optical member and the second optical member are arranged side by side in the same optical sheet, and a gap is formed between the first optical member and the second optical member.

Preferably, in the configuration described above, a reflective sheet is arranged close to a surface of the light guide plate on an opposite side to the optical sheet, and a light absorption member that absorbs the light is provided on the reflective sheet in a vicinity of the light source unit.

As an image display device that adopts the backlight unit configured as described above, there is a liquid crystal display device including: a liquid crystal panel unit on the side of a front surface of the backlight unit.

### Advantages of the Invention

According to the present invention, it is possible to provide a backlight unit that is an edge light-type backlight unit, that prevents the occurrence of unevenness of planar light and that can reduce consumption energy and a liquid crystal display device that utilizes such a backlight unit.

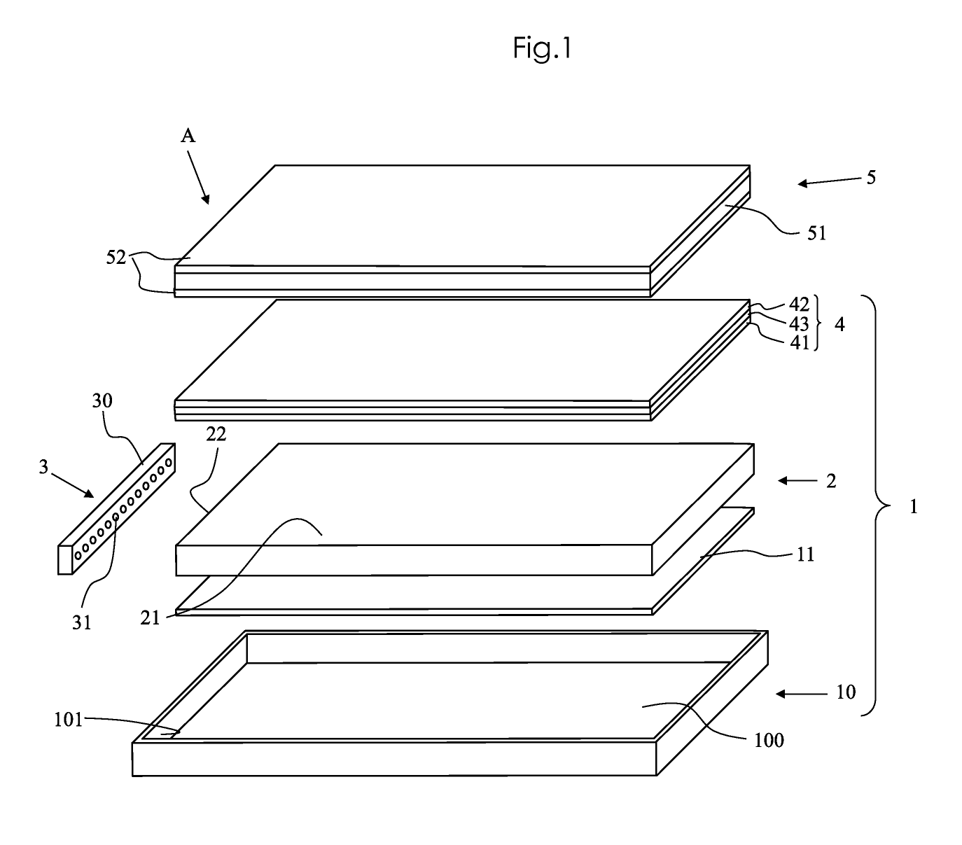

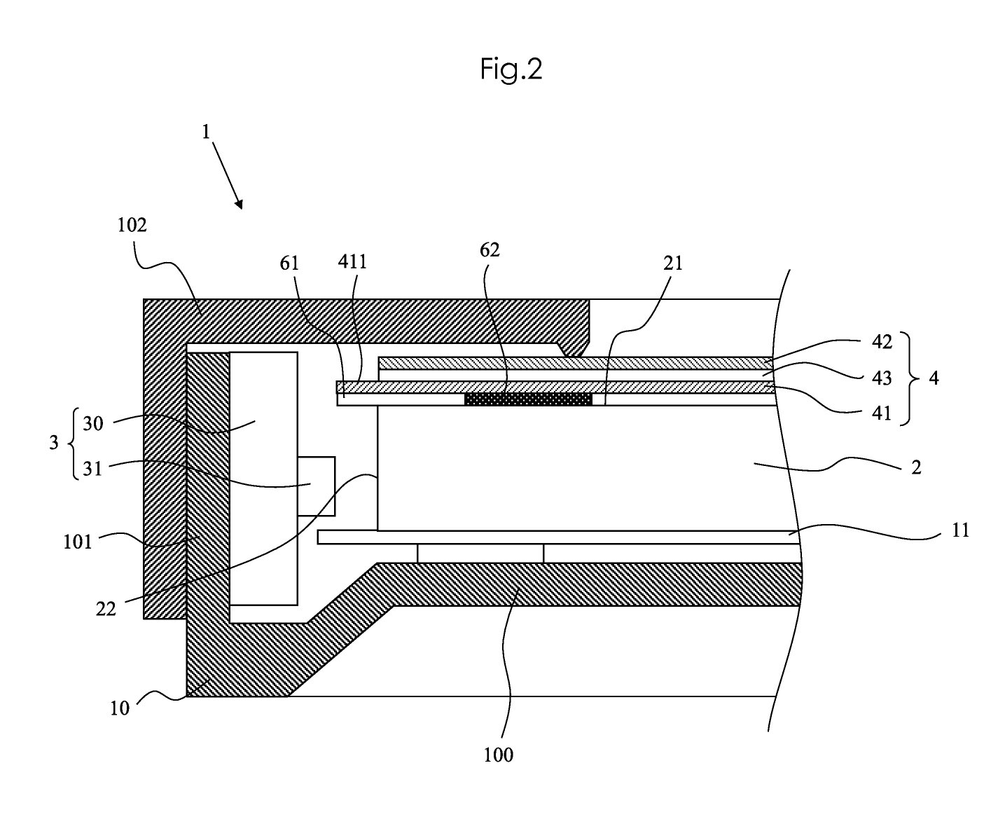

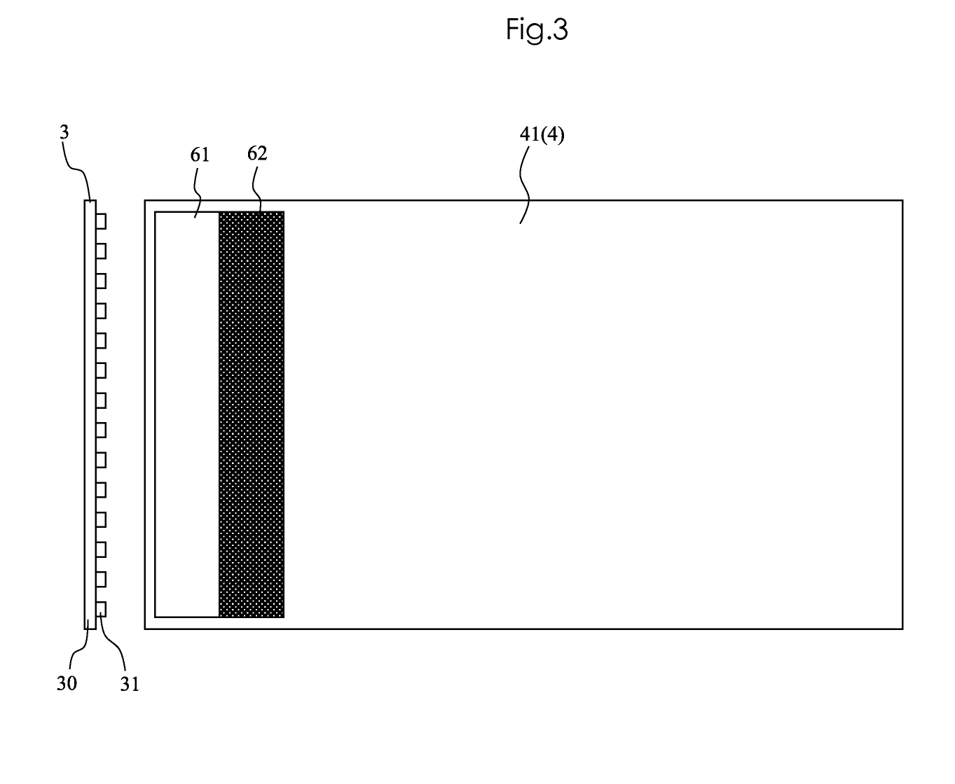

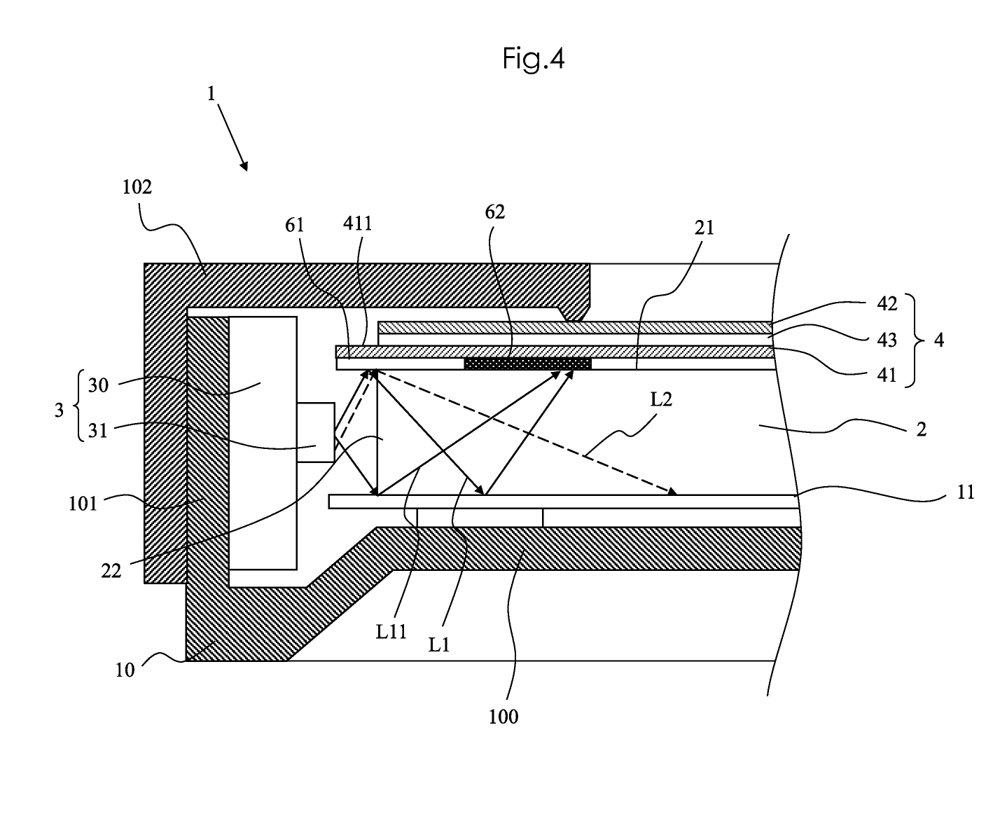

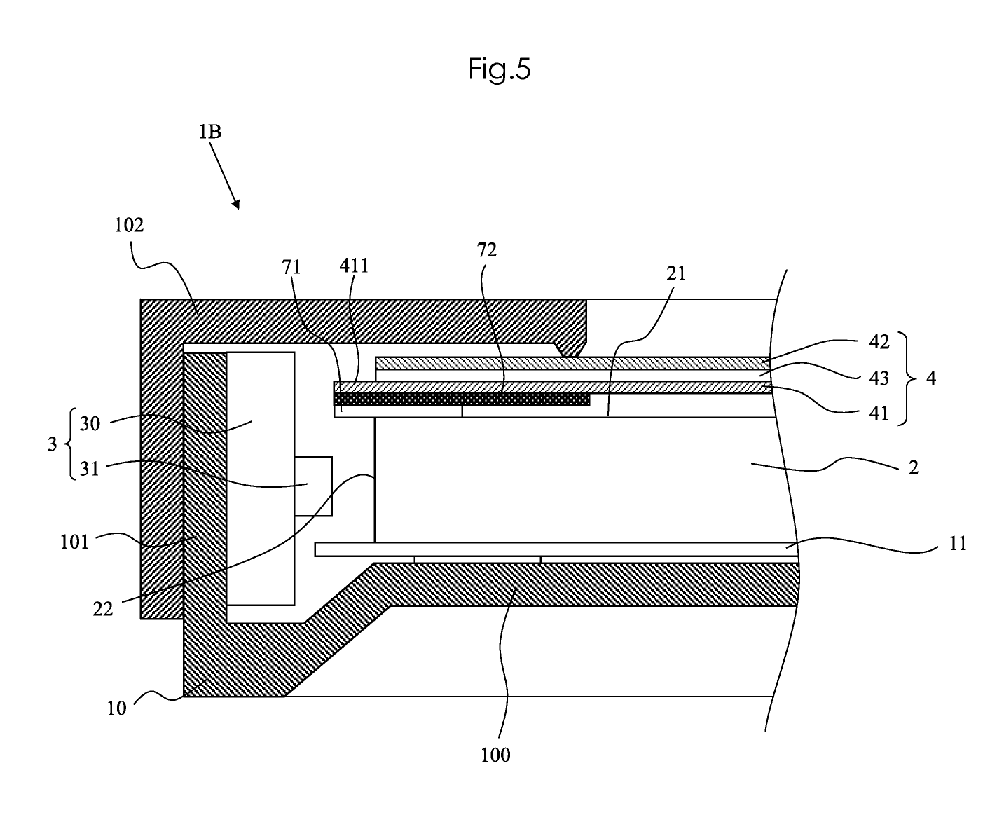

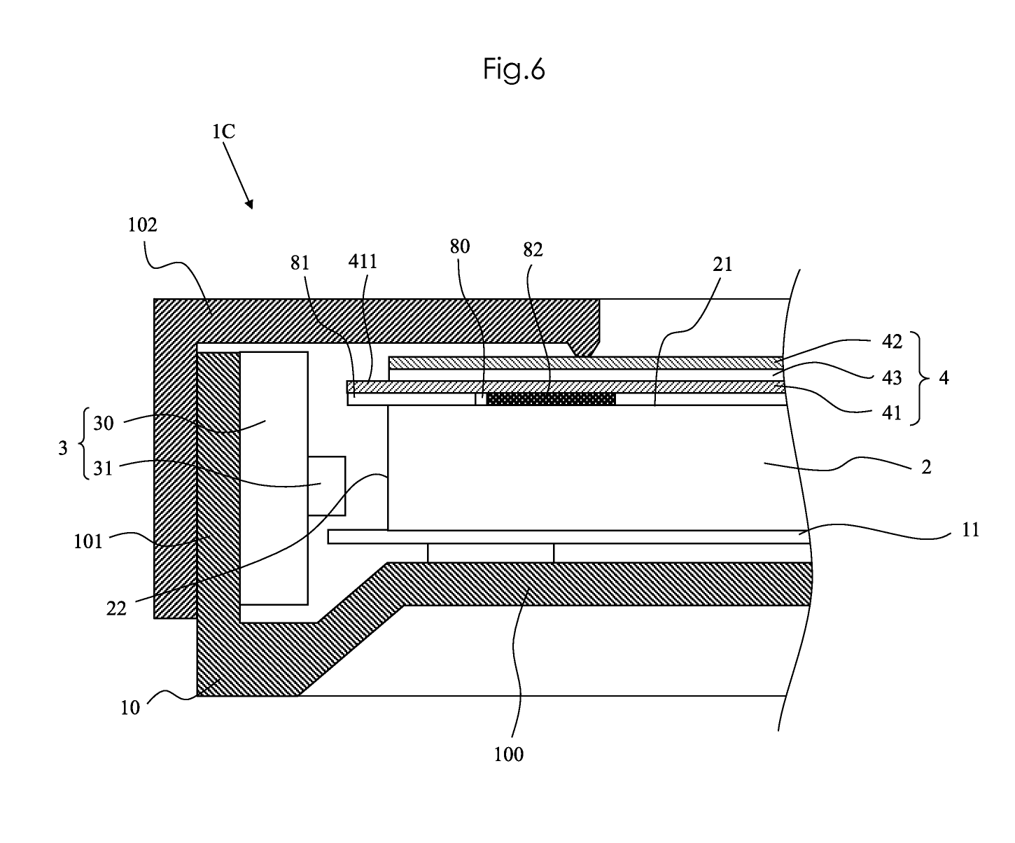

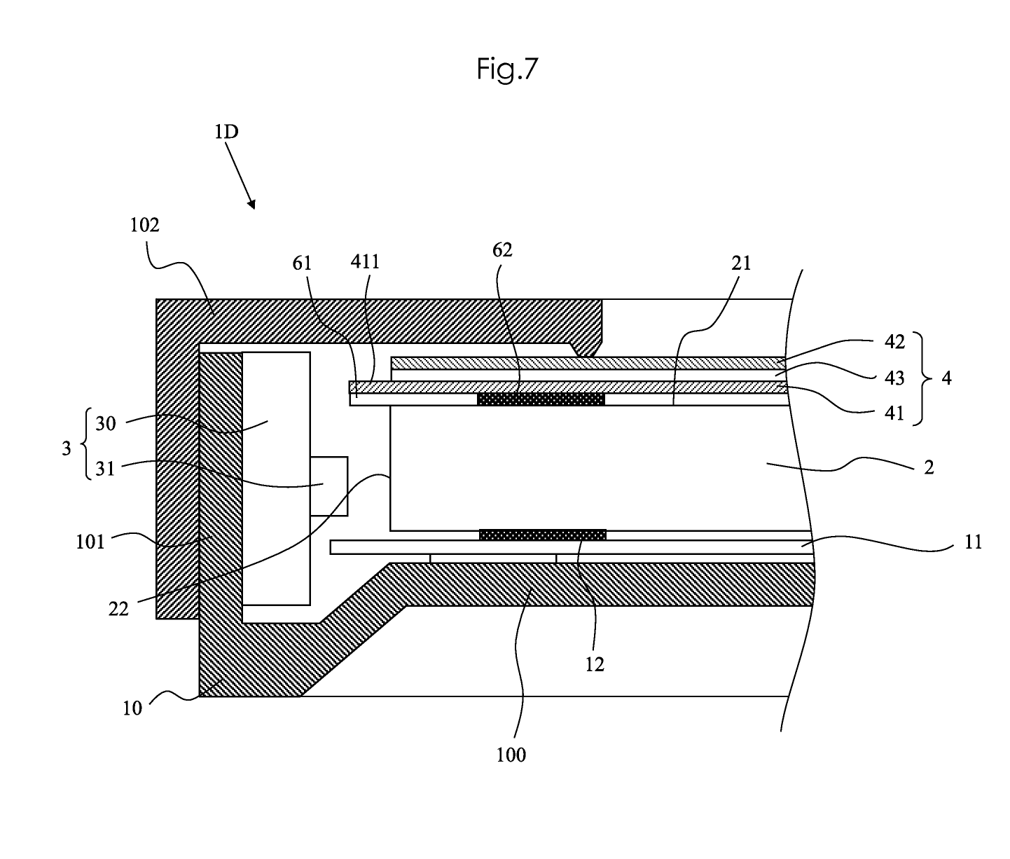

### BRIEF DESCRIPTION OF DRAWINGS

[FIG. 1] An exploded perspective view of an example of a liquid crystal display device including a backlight unit according to the present invention;

[FIG. 2] A cross-sectional view of the backlight unit included in the liquid crystal display device shown in FIG. 1;

[FIG. 3] A diagram when an optical sheet is seen from the side of a light guide plate;

[FIG. 4] A cross-sectional view showing the paths of light emitted from a light source unit;

[FIG. 5] A cross-sectional view of another example of the backlight unit according to the present invention;

[FIG. 6] A cross-sectional view of yet another example of the backlight unit according to the present invention; and

[FIG. 7] A cross-sectional view of yet another example of the backlight unit according to the present invention.

### DESCRIPTION OF EMBODIMENTS

Embodiments of the present invention will be described below with reference to accompanying drawings.

### First Embodiment

FIG. 1 is an exploded perspective view of an example of a liquid crystal display device including a backlight unit according to the present invention. As shown in FIG. 1, the liquid crystal display device A includes a backlight unit 1 and a liquid crystal panel unit 5; the liquid crystal panel unit 5 is arranged on the front surface side (the side of an observer) of the backlight unit 1. In the liquid crystal display device A shown in FIG. 1, a description will be given on the assumption that the upper side of the plane of the figure is the front side, that is, the side of the observer, and that the lower side is the back surface. Unless otherwise particularly described, the following description will be given with reference to the front surface and the back surface in the state of FIG. 1.

The liquid crystal panel unit 5 includes a liquid crystal panel 51 that liquid crystal is sealed in and polarization plates 52 that are adhered to the front surface (the side of the observer) and the back surface (the side of the backlight unit 1) of the liquid crystal panel 51. The liquid crystal panel 51 includes an array substrate, an opposite substrate arranged opposite the array substrate and the liquid crystal with which the space between the array substrate and the opposite substrate is filled.

In the array substrate, a source wiring and a gate wiring perpendicular to each other, a switching element (for example, a thin film transistor) connected to the source wiring and the gate wiring, a pixel electrode connected to the switching element, an oriented film and the like are provided. In the opposite substrate, a color filter in which the coloring portions of red, green and blue (RGB) are placed in a predetermined arrangement, a common electrode, an oriented film and the like are provided.

The switching element of the array substrate is driven by a drive signal, and thus voltage is applied between the array substrate and the opposite substrate in each of the pixels of the liquid crystal panel 51. The voltage between the array substrate and the opposite substrate is changed, and thus the degree of transmission of light in each of the pixels is changed. Thus, an image is displayed on an image display region on the side of the observer in the liquid crystal panel 51.

The backlight unit 1 is an illumination device that applies planar light to the liquid crystal panel unit 5. The backlight unit 1 includes a light guide plate 2 that is formed in the shape of a flat plate, a light source unit 3 that applies light to a light receiving surface 22 formed on the side surface of the light guide plate 2 and an optical sheet 4 that is arranged close to the light guide plate 2. The backlight unit 1 also includes a backlight chassis 10; at lease the light guide plate 2, the light source unit 3 and the optical sheet 4 are arranged within the backlight chassis 10.

### First Embodiment

The backlight unit 1 of the present invention will be described in detail with reference to the new drawings. FIG. 2 is a cross-sectional view of the backlight unit included in the liquid crystal display device shown in FIG. 1. As shown in FIG. 2, in the backlight unit 1, the light guide plate 2, the light source unit 3 and the optical sheet 4, which are described above, and furthermore a reflective sheet 11 are arranged within the backlight chassis 10. On the side of the front surface (the side of the liquid crystal panel unit) of the optical sheet 4, its side edge portion is pressed onto a chassis case 102.

As shown in FIGS. 1 and 2, the backlight chassis 10 is a box member whose front surface side (the side of the liquid crystal panel unit) is open, and includes a bottom portion 100 that is rectangular when seen in plan view and a side wall portion 101 protruding from the four sides of the bottom portion 100. As shown in FIG. 2, in the backlight unit 1, the reflective sheet 11, the light guide plate 2 and the optical sheet 4 are arranged in this order from the bottom portion 100. As shown in FIG. 2, the light source unit 3 is attached to the inner peripheral side of the side wall portion 101.

The light guide plate 2 is obtained by molding a transparent resin, such as poly-methyl methacrylate (PMMA) or polycarbonate, in the shape of a flat plate. The present invention is not limited to these resins, and resins that can be formed into the shape of a transparent flat plate can be widely adopted.

As shown in FIG. 1, the light guide plate 2 is a plate member that is rectangular when seen in plan view. The main surface opposite the liquid crystal panel unit 5 is formed as a light emitting surface 21, and one of the side surfaces in the longitudinal direction is formed as a light receiving surface 22 through which light is received from the light source unit 3.

The light source unit 3 includes a long substrate 30 that is arranged opposite the light receiving surface 22 and a plurality of LEDs 31 that are linearly arranged on the substrate 30. Although in the light source unit 3, the LEDs 31 are spaced regularly, they may be partially spaced different distances apart. As shown in FIG. 2, the substrate 30 is attached and fixed to the side wall portion 101 of the backlight chassis 10. Here, the substrate 30 is attached such that the LEDs 31 are on the inside of the backlight unit 1, that is, are arranged opposite the light receiving surface 22 of the light guide plate 2. Thus, the light emitted from the LEDs 31 enters through the light receiving surface 22.

The optical sheet 4 includes, as optical sheet members, diffusion sheet members 41 and 42 that diffuse light emitted from the light emitting surface 21 of the light guide plate 2 and a prism sheet member 43 that aligns the direction of the light emitted from the light emitting surface 21, that is, that changes the direction of light entering obliquely so that the light faces toward the liquid crystal panel unit 5. Optical sheet members having optical properties other than those described above may be used.

In the liquid crystal display device A shown in FIG. 1, the diffusion sheet members 41 and 42 and the prism sheet member 43 have such shapes and sizes as to cover the light emitting surface 21. Although the prism sheet member 43 is sandwiched between the two diffusion sheet members 41 and 42, the present invention is not limited to this configuration. On the surface of the sheet (here, the diffusion sheet member 41) of the optical sheet 4 closest to the light guide plate 2 on the side of the light guide plate 2, a first optical member 61 and a second optical member 62 are arranged. The first optical member 61 and the second optical member 62 will be described in detail later.

The light emitted from the LEDs 31 enters the light guide plate 2 through the light receiving surface 22. The light entering through the light receiving surface 22 is repeatedly reflected within the light guide plate 2, and is finally emitted as planar light through the light emitting surface 21. The entire light entering through the light receiving surface 22 is preferably emitted through the light emitting surface 21. However, in fact, light may be emitted through the main surface on the opposite side to the light emitting surface 21. Hence, between the bottom portion 100 of the backlight chassis 10 and the light guide plate 2, the reflective sheet 11 is arranged that reflects and returns the light emitted through the surface on the opposite side to the light emitting surface 21 to the light guide plate 2.

The LEDs 31 are a point light source, and the light emitted from the LEDs 31 is diffused light. Here, depending on the gap between the LEDs 31 and the light receiving surface 22, the light emitted from the LEDs 31 may be displaced from the light receiving surface 22. Hence, the end portions of the reflective sheet 11 and the optical sheet 4 on the side of the LEDs 31 are arranged to protrude to the side of the light source unit 3 as compared with the light receiving surface 22. In this way, the light displaced from the light receiving surface 22, of the light emitted from the LEDs 31, is applied to any of the optical sheet 4 and the reflective sheet 11. In the backlight unit 1, on only the diffusion sheet member 41 of the optical sheet 4, a protrusion portion 411 that protrudes from the light guide plate 2 to the side of the light source unit 3 is formed.

Here, the optical sheet will be described in detail with reference to the new drawing. FIG. 3 is a diagram when the optical sheet is seen from the side of the light guide plate. As shown in FIG. 2, on the side of the light guide plate of the diffusion sheet member 41 in the optical sheet 4 close to the light guide plate 2, the first optical member 61 and the second optical member 62 are arranged. As shown in FIGS. 2 and 3, the first optical member 61 is arranged on the side of the light source, and the second optical member 62 is arranged adjacent to the first optical member 61 on the opposite side to the light source. When the optical sheet 4 is arranged on the light guide plate 2, the first optical member 61 is formed on the end portion of the diffusion sheet member 41 including the protrusion portion 411 on the side of the light source unit 3.

The first optical member 61 is a reflective layer that reflects the light emitted from the LEDs 31, and its reflection rate is about 80 to 100%. Examples of the first optical member 61 include a member that adheres a resin film such as PET or acrylic and a member that is formed by printing with a white pigment such as titanium oxide or a dye. The present invention is not limited to these examples; as a method of forming the first optical member 61, a method of forming a layer that reflects light at a high reflection rate can be widely adopted.

In the backlight unit 1, the light entering through the light receiving surface 22 is repeatedly reflected (diffusely reflected) off the inside surface of the light guide plate 2, and is diffused within the light guide plate 2. Then, planar light whose brightness distribution becomes uniform to some degree is emitted through the light emitting surface 21. Here, when the light emitted from the LEDs 31 is emitted through the light emitting surface 21 in the vicinity of the light source unit 3 without being repeatedly reflected, the light is not sufficiently diffused, and in the planar light in the vicinity of the light source unit 3, a region (hereinafter referred to a bright line region or simply referred to a bright line) where its brightness is linearly increased as compared with the surrounding.

Hence, as shown in FIG. 3, the second optical member 62 that absorbs light is formed in a position adjacent to the first optical member 61 on the opposite side to the light source unit 3. The second optical member 62 is a layer that reduces the reflection of the light emitted from the LEDs 31, that is, a layer that absorbs the light, for example, a low-reflection layer that is formed such as by printing with a pigment or a dye of black, gray or the like. The second optical member 62 is formed, and thus needless (excessive) light is shielded (absorbed), with the result that the production of the bright line is reduced. The reflection rate of the second optical member 62 is about 0 to 70%, and is formed to be lower than that of the first optical member 61 without fail.

The structure of the first optical member and the second optical member in the backlight unit according to the present invention that reduces the bright line will be described with reference to the drawing. FIG. 4 is a cross-sectional view showing the paths of the light emitted from the light source unit. In FIG. 4, the paths of the light are indicated by arrow lines. In the backlight unit 1, causes for producing the bright line in the planar light are as follows. One of the causes is that light emitted from the light source (the LEDs 31) is displaced (leaks) from the light receiving surface 21, is diffusely reflected directly off the reflective sheet 11 and (or) the optical sheet 4 without entering the light guide plate 2 and is emitted to the front surface, that is, the cause results from so-called leakage light. The other one is that light entering the light emitting surface 21 in the vicinity of the light receiving surface 22, of the light entering the receiving surface 22 and having a small incident angle is not reflected off the inside surface of the light emitting surface 21 and is emitted through the light emitting surface 21.

Hence, in the backlight unit 1 of the present invention, as shown in FIG. 4, light displaced from the light receiving surface 22 of the light guide plate 2, of the light emitted from the LEDs 31 to the front surface side, is reflected off the first optical member 61 formed on the protrusion portion 411 of the diffusion sheet member 41, and enters through the light receiving surface 22. In this way, it is possible to reduce the production of the bright line by the entrance of the light emitted from the LEDs 31 into the liquid crystal panel unit 5 without the intervention of the light guide plate 2. Light displaced from the light receiving surface 22, of the light emitted from the LEDs 31 to the side of the bottom portion 100 of the backlight chassis 10, is reflected off the portion of the reflective sheet 11 protruding from the light receiving surface 22 to the side of the light source unit 3, and enters through the light receiving surface 22.

Since the light displaced from the light receiving surface 22, of the light emitted from the LEDs 31, is reflected off the first optical member 61 or the reflective sheet 11, and enters through the light receiving surface 22, the diffuse reflection of the light off the reflective sheet 11 and the optical sheet 4 to cause the light to leak from the front surface side is reduced. In this way, the production of the bright line by the leakage light is reduced. The light displaced from the light receiving surface 22, of the light emitted from the LEDs 31, can be reflected off the first optical member 61 formed on the protrusion portion 411 or the portion of the reflective sheet 11 protruding from the light guide plate 2, and can be made to enter through the light receiving surface 22. In this way, the decrease in the rate of utilization of the light is reduced.

Light L1 whose reflection angle is small, of the light emitted from the LEDs 31 and reflected off the first optical member 61, is reflected off the back surface (the interface with the reflective sheet) of the light guide plate 2, and enters the light emitting surface 21 at a small incident angle. Light L11 whose reflection angle is small, of the light emitted from the LEDs 31 and reflected off the back surface of the light guide plate 2, likewise enters the light emitting surface 21 at a small incident angle.

Here, a small incident angle will be described. When the light passing through the interior of the light guide plate 2 enters the end surface (including the light emitting surface 21) at an angle equal to or more than an angle (critical angle) determined by the refractive index of the light guide plate 2, the light is totally reflected off the end surface (the light emitting surface 21) and is not emitted to the outside. On the other hand, when the light enters the end surface at an angle smaller than the critical angle, part of the light is emitted to the outside; as the angle is decreased, the amount of light emitted to the outside is increased. Based on what has been described above, the incident angle that is equal to or less than such an incident angle that the amount of light emitted through the light emitting surface 21 is higher than a predetermined amount of light is assumed to be a small incident angle.

Since the light L1 whose reflection angle is small, of the light reflected off the first optical member 61, and the light L11 whose reflection angle is small, of the light reflected off the back surface of the light guide plate 2, enter the light emitting surface 21 at a small incident angle, they cause the bright line. Hence, the second optical member 62 is formed in the region, in the optical sheet 4, through which the light L1 (solid lines in the figure) whose reflection angle is small when the light is reflected off the first optical member 61, and the light L11 whose reflection angle is small when the light is reflected off the reflective sheet pass, and thus the amounts of the light L1 and the light L11 are reduced.

The light L2 (dotted lines in the figure) whose reflection angle is large, of the light reflected off the first optical member 61 arranged on the protrusion portion 411 is unlikely to cause the bright line. Since the second optical member 62 is not formed in a place where the light L2 whose reflection angle is large reaches the light emitting surface 21, the light is not absorbed by the second optical member 62 and is utilized as part of the planar light.

As described above, the first optical member 61 and the second optical member 62 are formed, and thus the emission of the light entering the light guide plate 2 through a portion of the light emitting surface 21 in the vicinity of the light source unit 3 with the amount of the light being high (in other words, in a state where the diffusion by reflection within the light guide plate 2 is insufficient) is reduced. Furthermore, it is possible to reduce the production of the leakage light that does not enter through the light receiving surface 22, of the light emitted from the light source unit 3 (the LEDs 31). In this way, it is possible to reduce the formation of the bright line in a portion of the planar light emitted from the backlight unit 1 close to the light source unit 3. Since the light that is temporarily displaced from the light receiving surface 22 is reflected off the first optical member 61 and the reflective sheet 11 to be returned to the light receiving surface 22, it is possible to increase the rate of utilization of the light.

Although as described above, the light is completely shielded by the second optical member 62, the second optical member 62 may be configured to absorb (or reflect) the light such a degree that the brightness of the region where the bright line of the planar light is produced is equal to that of the surrounding. As shown in FIG. 3, in the side edge portion of the diffusion sheet member 4, a gap region where the first optical member 61 and (or) the second optical member 62 are not formed is present. This gap region is formed to reduce a problem in which a glue is excessively extended when the first optical member 61 and (or) the second optical member 62 are formed by adhering a sheet and a problem in which printing comes off when the first optical member 61 and (or) the second optical member 62 are formed by printing; however, the gap region is preferably minimized or removed. The same is true in the following embodiments.

Furthermore, although in the backlight unit 1, the first optical member 61 and the second optical member 62 are formed on the diffusion sheet member 41 arranged on the side of the optical sheet 4 closest to the light guide plate 2, the present invention is not limited to this configuration. The first optical member 61 and the second optical member 62 may be formed on another optical sheet member. The first optical member 61 and (or) the second optical member 62 may be formed on each of the optical sheet members 41, 42 and 43. Furthermore, the optical sheet member where the first optical member 61 is formed and the optical sheet member where the second optical member 62 is formed differ from each other in configuration.

### Second Embodiment

Another example of the backlight unit according to the present invention will be described with reference to the drawing. FIG. 5 is a cross-sectional view of the other example of the backlight unit according to the present invention. The backlight unit 1B shown in FIG. 5 has the same configuration as the backlight unit 1 of the first embodiment except that a first optical member 71 and a second optical member 72 formed on the diffusion sheet member 41 of the optical sheet 4 differ from each other in shape; the substantially the same portions are identified with the same symbols, and their description will not be repeated.

As shown in FIG. 5, in the backlight unit 1B, the second optical member 72 is formed on the diffusion sheet member 41 in the vicinity of the light source unit 3, and the first optical member 71 is formed on the upper portion (the side of the light guide plate 2) of the second optical member 72 in the vicinity of the light source unit 3.

In the backlight unit 1B, since the second optical member 72 is formed on the surface of the diffusion sheet member 41, and thereafter the first optical member 71 is formed without undergoing a step of removing the second optical member 72, it is possible to produce the second optical member 72 and the first optical member 71 in a smaller number of steps. In this way, it is possible to reduce the effort and time of the manufacturing.

Contrary to what has been described above, the first optical member 71 may be formed on the diffusion sheet member 41, and the second optical member 72 may be formed on the upper portion (the side of the light guide plate 2) of the first optical member 71. As the second optical member 72, it is possible to adopt a member that can reduce the amount of transmission when light is transmitted. Even in this case, when the diffusion sheet member 41 is seen from the side of the light guide plate 2, the first optical member 71 is on the side of the light source as compared with the second optical member 72. The shapes of the optical sheet member on which the first optical member 71 and the second optical member 72 are arranged and the first optical member 71 and the second optical member 72 are the same as in the first embodiment.

The other effects in the second embodiment are the same as in the first embodiment.

### Third Embodiment

Yet another example of the backlight unit according to the present invention will be described with reference to the drawing. FIG. 6 is a cross-sectional view of the other example of the backlight unit according to the present invention. The backlight unit 1C shown in FIG. 6 has the same configuration as the backlight unit 1 of the first embodiment except that a first optical member 81 and a second optical member 82 formed on the diffusion sheet member 41 of the optical sheet 4 differ from each other in shape; the substantially the same portions are identified with the same symbols, and their description will not be repeated.

As shown in FIG. 6, in the backlight unit 1C, on the diffusion sheet member 41 in the vicinity of the light source unit 3, the first optical member 81 is formed, and on the opposite side to the light source unit 3, the second optical member 82 is formed. The first optical member 81 and the second optical member 82 are arranged with a gap 80 left therebetween.

As described above, the first optical member 81 and the second optical member 82 are arranged with the gap 80 left, and thus when the first optical member 81 and the second optical member 82 are formed, it is possible to reduce the interference (mixing) of the materials of both members with each other. In this way, it is possible to provide the backlight unit 1C that enhances the efficiency of utilization of the light and the effect of reducing the bright line.

The other effects in the third embodiment are the same as in the first and second embodiments.

The shapes of the optical sheet member on which the first optical member 81 and the second optical member 82 are arranged and the first optical member 81 and the second optical member 82 are the same as in the first embodiment.

### Fourth Embodiment

Yet another example of the backlight unit according to the present invention will be described with reference to the drawing. FIG. 7 is a cross-sectional view of the other example of the backlight unit according to the present invention. The backlight unit 1D shown in FIG. 6 has the same configuration as the backlight unit 1 of the first embodiment except that a light absorption member 12 is formed on the reflective sheet 11; the substantially the same portions are identified with the same symbols, and their description will not be repeated.

Part of the light emitted from the LEDs 31 enters through the light receiving surface 22, is then directly reflected off the reflective sheet 11 and enters the bright line region. In order to reduce the part of the light reflected off the reflective sheet 11 that enters the bright line region as described above, the light absorption member 12 is provided on the reflective sheet 11. As described above, the light absorption member 12 is provided, and thus it is possible to reduce the size (the width in a direction away from the light source unit 3) of the second optical member 62 arranged on the diffusion sheet member 41.

Although in the backlight unit 1D of the present embodiment, the light absorption member 12 is formed on the reflective sheet 11 including the first optical member 61 and the second optical member 62 having the same configuration as in the first embodiment, the present invention is not limited to this configuration; the backlight unit of the second embodiment or the third embodiment can be adopted.

The other effects in the fourth embodiment are the same as in the first to third embodiments.

Although the embodiments of the present invention have been described above, the present invention is not limited to the details thereof. In the embodiments of the present invention, various modifications are possible without departing from the spirit of the invention.

### INDUSTRIAL APPLICABILITY

The backlight unit and the liquid crystal display device according to the present invention can be utilized as the display portions of electronic devices such as information appliances, notebook PCs, mobile telephones and play devices.

### LIST OF REFERENCE SYMBOLS

1 backlight unit

2 light guide plate

21 light emitting surface

22 light receiving surface

3 light source unit

30 substrate

31 LED

4 optical sheet

41, 42 diffusion sheet member

43 prism sheet member

5 liquid crystal panel unit

61, 71, 81 first optical member

62, 72, 82 second optical member

1. A backlight unit comprising:
a light source;
a light guide plate in which light from the light source enters through a light receiving surface on a side surface and in which planar light is emitted through a light emitting surface on a main surface;
an optical sheet that includes a protrusion portion which is arranged on a side of the light receiving surface of the light guide plate and which protrudes to a side of the light source as compared with the light guide plate;
a first optical member that is formed on the protrusion portion and a portion of the optical sheet close to the light source and that reflects the light; and
a second optical member that is formed on an opposite side to the light source with respect to the first optical member of the optical sheet and that absorbs part or all of the light entering the light guide plate.

2. The backlight unit of claim 1,
wherein the second optical member has a reflection rate lower than the first optical member.

3. The backlight unit of claim 1,
wherein the second optical member reduces an amount of transmission of the light entering the light guide plate.

4. The backlight unit of claim 1,
wherein the optical sheet includes a plurality of optical sheet members,
the first optical member is formed on at least one of the optical sheet members and
the second optical member is formed on at least one of the optical sheet members.

5. The backlight unit of claim 4,
wherein at least the first optical member is formed on the optical sheet member closest to the light guide plate.

6. The backlight unit of claim 1,
wherein the second optical member is formed on an upper surface of the optical sheet, and the first optical member is formed on an upper surface of the second optical member.

7. The backlight unit of claim 1,
wherein the first optical member and the second optical member are arranged side by side in the same optical sheet, and a gap is formed between the first optical member and the second optical member.

8. The backlight unit of claim 1,
wherein a reflective sheet is arranged close to a surface of the light guide plate on an opposite side to the optical sheet, and
a light absorption member that absorbs the light is provided on the reflective sheet in a vicinity of the light source unit.

9. A liquid crystal display device comprising:
the backlight unit of claim 1; and
a liquid crystal panel unit on a side of a front surface of the backlight unit.
